(19) United States
(12) Patent Application Publication
(10) Pub. No.: US 2015/0249566 A1
(43) Pub. Date: Sep. 3, 2015

(54) APPARATUS FOR SELECTING MASTER IN REDUNDANCY SYSTEM

(71) Applicant: ELECTRONICS AND TELECOMMUNICATIONS RESEARCH INSTITUTE, Daejeon (KR)

(72) Inventors: Beob Kyun KIM, Daejeon (KR); Kwang Yong LEE, Daejeon (KR)

(21) Appl. No.: 14/597,402

(22) Filed: Jan. 15, 2015

(30) Foreign Application Priority Data
Feb. 28, 2014 (KR) 10-2014-0024171

(51) Int. Cl. H04L 12/24; H04L 12/741; H04L 12/26

(52) U.S. Cl. CPC H04L 41/0654; H04L 43/10; H04L 45/745

(57) ABSTRACT

An apparatus for selecting a master in a redundancy system, which can rapidly select a single master among a plurality of backups by selecting a master through negotiation among backups when a failure occurs in the master in a redundancy system with one or more backups.

### CROSS-REFERENCE TO RELATED APPLICATIONS

This application claims priority to and the benefit of Korean Patent Application No. 10-2014-0024171 filed in the Korean Intellectual Property Office on Feb. 28, 2014, the entire contents of which are incorporated herein by reference.

### TECHNICAL FIELD

The present invention relates to an apparatus for selecting a master in a redundancy system, and more particularly, to a technology that selects a master among backups when a failure occurs in a master module (hereinafter, referred to as a master) in a redundancy system with one or more backup modules (hereinafter, referred to as backups).

### BACKGROUND ART

In general, a redundancy system including a backup that take a function of a master in the case of the master's failure to provide continuous service to the client.

In the redundancy system, an independent operating system is installed in duplicated hardware devices and thereafter, one hardware device is selected as the master to perform a normal function and the other hardware device serves as the backup.

In this case, the master periodically sends ‘Heartbeat’ indicating that the master itself normally operates to the backup and the backup determines whether the master normally operates based on the ‘Heartbeat’ received from the master. That is, the backup operates in a master mode to provide a continuous service (function) when not receiving the ‘Heartbeat’ or abnormally receiving the ‘Heartbeat’ from the master.

In the redundancy system in the related art, when the failure occurs in the master, one backup exists that can substitute for the master, and as a result, it is not difficult to select a new master, but when a plurality of backups is provided, a method for selecting the new master is not mentioned.

### SUMMARY OF THE INVENTION

The present invention has been made in an effort to provide an apparatus for selecting a master in a redundancy system, which can rapidly select a single master among a plurality of backups by selecting the master through negotiation among the backups when a failure occurs in the master in the redundancy system with one or more backups.

An exemplary embodiment of the present invention provides an apparatus installed in one backup and selecting a new master in a redundancy system with a master and one or more backups, the apparatus including: a communication unit which communicates with the master and other backups to sense a failure of the master; a mode negotiation unit which creates a negotiation table and transmits the created negotiation table to the other backups through the communication unit as the failure occurs in the master and determines whether to convert a mode based on the corresponding negotiation table received from the other backups through the communication unit; and a mode conversion unit which requests the mode conversion to an application when a current mode is set to the master mode by the mode negotiation unit.

According to the exemplary embodiment of the present invention, a single master can be rapidly selected among a plurality of backups by selecting a master through negotiation among backups when a failure occurs in the master in a redundancy system with one or more backups.

The foregoing and other objects, features, aspects and advantages of the present disclosure will be understood and become more apparent from the following detailed description of the present disclosure. Also, it can be easily understood that the objects and advantages of the present disclosure can be realized by the units and combinations thereof recited in the claims.

### BRIEF DESCRIPTION OF THE DRAWINGS

FIG. 1 is a configuration diagram of a redundancy system with one or more backups according to an exemplary embodiment of the present invention.

FIG. 2 is a configuration diagram of an apparatus for selecting a master in a redundancy system according to an exemplary embodiment of the present invention.

FIG. 3 is a flowchart of a method for selecting a master in a redundancy system according to an exemplary embodiment of the present invention.

FIG. 4 is a flowchart of a process in which a communication unit in a master selecting apparatus invokes a mode negotiation unit according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Prior to this, terms or words used in the present specification and claims should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner. Therefore, configurations illustrated in the embodiments and the drawings described in the present specification are only the most preferred embodiment of the present invention and do not represent all of the technical spirit of the present invention, and thus it is to be understood that various equivalents and modified examples, which may replace the configurations, are possible when filing the present application.

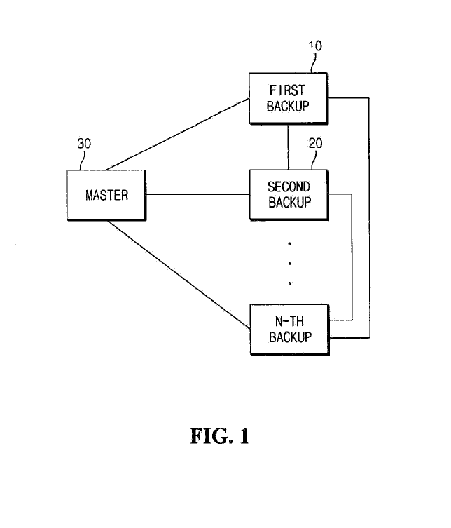

FIG. 1 is a configuration diagram of a redundancy system with one or more backups according to an exemplary embodiment of the present invention.

As illustrated in FIG. 1, the redundancy system with one or more backups according to the present invention includes a plurality of backups (a first backup 10, a second backup 20, . . . , an n-th backup) and a master 30 providing a service to a client at present.

First, the first backup 10 periodically transmits and receives ‘Heartbeat’ to and from the second backup 20 and the master 30 and the second backup 20 periodically transmits and receives the ‘Heartbeat’ to and from the first backup 10 and the master 30.

When the first backup 10 determines that a failure occurs in the master 30, the first backup 10 transmits and receives a negotiation table to and from the second backup 20 to perform negotiation for master selection In this case, the master is selected based on an IP address and an MAC address.

That is, the first backup 10 compares an IP address thereof and an IP address of the second backup 20 to operate in the master mode when the IP address thereof is the lower. The first backup 10 compares an MAC address thereof and an MAC address of the second backup 20 to operate in the master mode when the MAC address thereof is the lower.

In the example, two backups have been described as an example for easy description, but even when three or more backups exist, it is apparent that the example can be applied similarly.

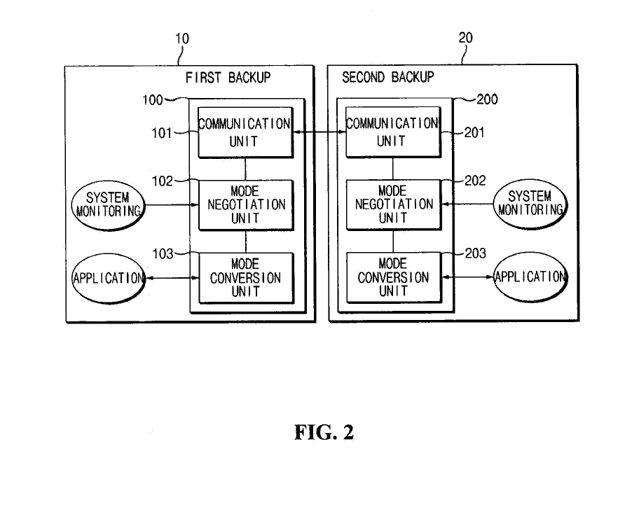

FIG. 2 is a configuration diagram of an apparatus for selecting a master in a redundancy system according to an exemplary embodiment of the present invention.

As illustrated in FIG. 2, the apparatuses 100 and 200 for selecting a master in a redundancy system according to the present invention are installed in the first backup 10 and the second backup 20, and include communication units 101 and 201, mode negotiation units 102 and 202, and mode conversion units 103 and 203. Of course, the master selecting apparatus is installed even in the master and when more backups exist, the master selecting apparatuses are installed in all the backups.

Hereinafter, respective components will be described based on the master selecting apparatus 100 installed in the first backup 10.

First, the communication unit 101 communicates with the communication unit 201 of the second backup 20 and the master 30. That is, the communication unit 101 periodically transmits the ‘Heartbeat’ to the master 30 and the communication unit 201 of the second backup 20 and periodically receives the ‘Heartbeat’ from the master 30 and the communication unit 201 of the second backup 20.

In this case, the ‘Heartbeat’ transmitted by the communication unit 101 of the first backup 10 includes information of the first backup 10, the ‘Heartbeat’ transmitted by the communication unit 201 of the second backup 20 includes information of the second backup 20, and the ‘Heartbeat’ transmitted by the master 30 includes information of the master 30. The ‘Heartbeat’ is shown in [Table 1] below as an example.

TABLE 1

| Field | Information |
|---|---|
| Group ID | Group identifier |
| Shared IP | When backup becomes master, virtual IP to be used |
| Running Mode | Execution mode (master or backup) |
| Heartbeat Interval | Heartbeat period |
| Host Key | Authentication information for determining whether |
| | corresponding host is forged |

The communication unit 101 determines effectiveness of the ‘Heartbeat’ received from the master 30 and the communication unit 201 of the second backup 20. That is, the communication unit 101 verifies whether effective ‘Heartbeat’ received during a maximum allowed ‘Heartbeat’ loss period (MaxHL) exists and invokes the mode negotiation unit 102 when the effective ‘Heartbeat’ does not exist. The MaxHL is defined as shown in [Equation 1] below as an example.

MaxHL=(Heartbeat Interval)×(Max Heartbeat Loss) [Equation 1]

When the communication unit 101 receives the ‘Heartbeat’, the communication unit 101 first analyzes ‘Host Key’ to determine whether the analyzed ‘Host Key’ is information transmitted from a forged host and compares ‘Group ID’, ‘Shared IP’, ‘Heartbeat Interval’, and the like to determine whether effective information of the same group is provided. If the information is forged or not effective, it is regarded that the ‘Heartbeat’ is not received.

Next, the mode negotiation unit 102 is invoked by the communication unit 101 and transmits and receives data (a negotiation table) configured by information required for mode negotiation to determine whether to switch a mode.

The mode negotiation unit 102 may be invoked by a system monitoring module. That is, when the system monitoring module determines that a normal operation of the system is difficult, the system monitoring module may speak its mind to stop an operation of the master.

A sample in which the mode negotiation unit 102 is invoked is described as shown in [Table 2] below as an example.

TABLE 2

| Case | Information | From |
|---|---|---|
| NO_HEARBEAT | Heartbeat is not received during | Communication unit |
| | MaxHL | |
| TOO_MANY_MASTER | Two or more masters exist in group | Communication unit |
| NO_MASTER | No master exists in group | Communication unit |
| ALARM | Request by monitoring module, and | Monitoring module, |
| | the like | and the like |

The mode negotiation unit 102 invoked as above configures the table required for the mode negotiation and a fundamental configuration thereof is shown in [Table 3] below.

TABLE 3

| Field | Information | |
|---|---|---|
| Error-Code | Casue for progress of mode | |
| | negotiation | |
| MY_CUR_MODE | Current execution mode at | MASTER or BACKUP |
| | transmitting side | |
| YOUR_CUR_MODE | Current execution mode at receiving | MASTER or BACKUP |
| | side | |
| MY_NEW_MODE | Mode after mode switching at | MASTER or BACKUP |
| | transmitting side | |
| YOUR_NEW_MODE | Mode after mode switching at | MASTER or BACKUP |
| | receiving side | |
| TIME_THIS_MODE | Start time of current mode | |
| | (MY_CUR_MODE) | |
| MY_IP | IP address at transmitting side | |
| MY_MAC | MAC address at transmitting side | |

The mode negotiation unit 102 transmits a first negotiation table to the mode negotiation unit 202 of the second backup 20 and receives a second negotiation table from the mode negotiation unit 202 of the second backup 20. In this case, the first negotiation table includes the information of the first backup 10 and the second negotiation table includes the information of the second backup 20.

Thereafter, the mode negotiation unit 102 compares an IP address thereof and the IP address of the second backup 20 to set a current mode to the master mode when the IP address thereof is the lowest, based on the first negotiation table and the second negotiation table. In this case, when the IP address of the second backup 20 is low, the mode negotiation unit 202 of the second backup 20 sets the current mode to the master mode.

For example, when the IP address of the first backup 10 is 210.109.33.21 and the IP address of the second backup 20 is 210.109.33.22, the first backup operates in the master mode.

The mode negotiation unit 102 may compare an MAC address thereof and the MAC address of the second backup 20 to set a current mode to the master mode when the MAC address thereof is the lowest, based on the first negotiation table and the second negotiation table. In this case, when the MAC address of the second backup 20 is low, the mode negotiation unit 202 of the second backup 20 sets the current mode to the master mode.

Next, the mode conversion unit 103 notifies mode conversion to an application when the current mode is set to the master mode by the mode negotiation unit 102.

That is, the mode conversion unit 103 is invoked by the mode negotiation unit 102 to exchange a message including information shown in [Table 4] below with the application.

The mode conversion unit 103 notifies to registered applications that the mode conversion starts and when the mode conversion unit 103 receives responses from all of the applications, the mode conversion unit 103 requests mode conversion simultaneously to prevent a malfunction caused due to mode inconsistency among the applications.

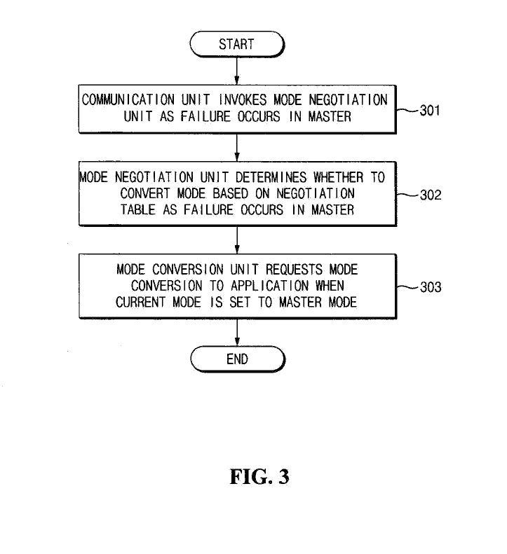

FIG. 3 is a flowchart of a method for selecting a master in a redundancy system according to an exemplary embodiment of the present invention. In the redundancy system with the master and one or more backups, a process in which a master selecting apparatus installed in one backup selects the new master is illustrated.

First, the communication unit 101 communicates with the master 30 and when the failure occurs in the master 30, the communication unit 101 invokes the mode negotiation unit 102 (301). When the communication unit 101 receives the effective ‘Heartbeat’ while the one backup operates as the master, the communication unit 101 determines that two masters exist simultaneously to invoke the mode negotiation unit 102.

Thereafter, the mode negotiation unit 102 creates the negotiation table and transmits the created negotiation table to other backups through the communication unit 101 as the failure occurs in the master, and determines whether to convert the mode based on the corresponding negotiation table received from the other backups through the communication unit 101 (302). In this case, effectiveness of the received corresponding negotiation table is examined.

Next, the mode conversion unit 103 requests the mode conversion to the application when the current mode is set to the master mode by the mode negotiation unit 102 (303). In this case, when the current mode is not set to the master mode, the backup set in the master mode is registered as the master.

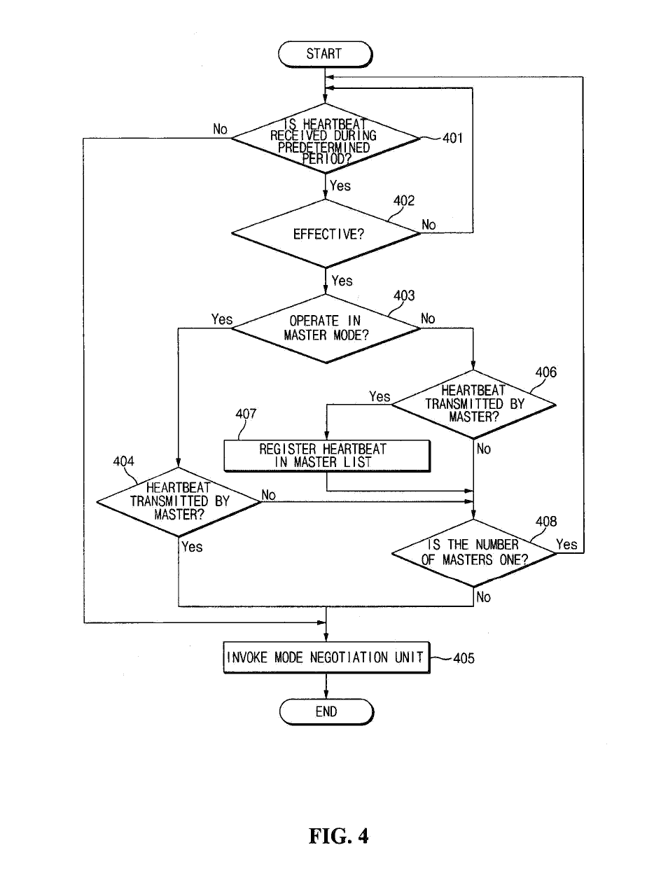

FIG. 4 is a flowchart of a process in which a communication unit in a master selecting apparatus invokes a mode negotiation unit according to an exemplary embodiment of the present invention.

First, when the communication unit 101 does not receive the ‘Heartbeat’ during a predetermined period (401), the communication unit 101 invokes the mode negotiation unit 102 (405) and when the communication unit 101 receives the ‘Heartbeat’, the communication unit 101 determines the effectiveness (402).

According to the determination result (402), when the ‘Heartbeat’ is not effective, the process proceeds to step “401” and when the ‘Heartbeat is effective, the communication unit it determines whether the communication unit 101 is operating in the maser mode (403).

According to the determination result (403), when the communication unit 101 is operating in the master mode, in the case where the execution mode in the received ‘Heartbeat’ is the master mode (404), the communication unit 101 invokes the mode negotiation unit 102 (405) and in the case where the execution mode in the ‘Heartbeat’ is not the master mode (404), the process proceeds to step “408”.

According to the determination result (403), when the communication unit 101 is not operating in the master mode, in the case where the execution mode in the received ‘Heartbeat’ is the master mode (406), the process proceeds to step “408 after registering the master in a master list (407) and in the case where the execution mode in the received ‘Heartbeat’ is not the master mode (406), the communication unit 101 determines whether the number of masters in the redundancy system is one (408).

According to the determination result (408), when the number of masters in the redundancy system is one, the process proceeds to step “401” and when the number of masters in the redundancy system is not one, the communication unit 101 invokes the mode negotiation unit 102 (405).

Meanwhile, the aforementioned method of the present invention can be prepared by a computer program. Codes and code segments constituting the program can be easily deduced by a computer programmer skilled in the art. The prepared program is stored in a computer readable recording medium (information storage medium) and is read and executed by a computer to implement the method of the present invention. The recording medium includes all types of computer readable recording media.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

What is claimed is:

1. An apparatus installed in one backup and selecting a new master in a redundancy system with a master and one or more backups, the apparatus comprising:
a communication unit which communicates with the master and other backups to sense a failure of the master;
a mode negotiation unit which creates a negotiation table and transmits the created negotiation table to the other backups through the communication unit as the failure occurs in the master and determines whether to convert a mode based on the corresponding negotiation table received from the other backups through the communication unit; and
a mode conversion unit which requests the mode conversion to an application when a current mode is set to the master mode by the mode negotiation unit.

2. The apparatus of claim 1, wherein the negotiation table includes an IP address and an MAC address.

3. The apparatus of claim 2, wherein the mode negotiation unit compares an IP address thereof and IP addresses of other backups to set the current mode to the master mode when the IP address thereof is the lowest.

4. The apparatus of claim 2, wherein the mode negotiation unit compares an MAC address thereof and MAC addresses of other backups to set the current mode to the master mode when the MAC address thereof is the lowest.

5. The apparatus of claim 1, wherein the communication unit determines that the failure occurs in the master when not receiving effective ‘Heartbeat’ during a predetermined period.

6. The apparatus of claim 5, wherein the ‘Heartbeat’ is a message including a group identifier, a virtual IP to be used when the backup becomes the master, an execution mode, a ‘Heartbeat’ period, and authentication information.

7. The apparatus of claim 1, wherein the mode negotiation unit is invoked by a system monitoring module.

8. The apparatus of claim 1, wherein the mode conversion unit notifies to applications that the mode conversion starts and when receiving responses from all of the applications, the mode conversion unit request the mode conversion to prevent a malfunction caused due to mode inconsistency among the applications.
